(19) United States
(12) Patent Application Publication
(10) Pub. No.: US 2006/0161809 A1
(43) Pub. Date: Jul. 20, 2006

(54) Disk connection unit, disk package, disk apparatus and disk connection method

(75) Inventor: Mitsuru Maejima, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/104,493

(22) Filed: Apr. 13, 2005

(30) Foreign Application Priority Data
Jan. 14, 2005 (JP) 2005-006973

(51) Int. Cl. G06F 11/00

(52) U.S. Cl. 714/6

(57) ABSTRACT

There are provided a disk connection unit, a disk package, a disk apparatus and a disk connection method that can improve the speed of operation and the reliability of the RAID categories. A disk connection unit 31 to be used to utilize a plurality of disks 32 by means of a single disk interface 21 comprises disk connectors dedicated to the respective disks 32 in order to connect the respective disks, a RAID control section that performs RAID control operations on the plurality of disks 32 by way of the disk connectors and a disk interface connector that connects the RAID control section to the disk interface 21.

### BACKGROUND OF THE INVENTION

1. Field of the Invention

This invention relates to a disk connection unit, a disk package, a disk apparatus and a disk connection method involving the use of RAID.

2. Description of Related Art

The disk apparatus that have been used for computers in recent years are mostly made to operate at high speed and have a large capacity. Disk apparatus having a feature of RAID (redundant array of inexpensive disks), or using a large number of disks, are being marketed. For example, disk apparatus of the RAID-0 category are designed to realize a high-speed operation by striping, or dividing data among a plurality of disks and transferring them in parallel. Disk apparatus of the RAID-1 category are designed to prevent loss of data due to a failure by mirroring, or transferring same data to a plurality of disks in parallel.

The arrangement of known disk apparatus will be described here. FIG. 4 of the accompanying drawings is a schematic block diagram of a known disk apparatus, showing the configuration thereof. The disk apparatus comprises a RAID control section 10, a backboard 20 and a plurality of disks 130. The backboard 20 includes disk interfaces (I/F) 21 dedicated to the respective disks 130 and a hub 22.

The RAID control section 10 performs RAID control operations on the plurality of disks 130 according to the commands issued from an external host. The backboard 20 is a substrate for arranging the plurality of disks 130 thereon. The disk interfaces 21 are connectors for connecting the respective disks 130. They are arranged on the backboard 20 at intervals that correspond to the standard size of the disks 130. The disks 130 are connected respectively to the corresponding disk interfaces 21.

Data are transferred to and from the backboard 20 by way of FCs (fiber channels) showing a sufficiently high data transfer rate relative to the data transfer rate of the disks 130. For instance, while the data transfer rate of the disks 130 may be hundreds of several Mbits per second, that of the FCs may be several Gbits per second.

However, it is difficult to prevent loss of data and exchange the liveliness of disks. Therefore, it is necessary to make arrangements for a RAID 0+1 category. Then, it is necessary to remarkably increase the number of disks 130 for such measures. However, both the number of disk interfaces 21 that can be arranged on a backboard 20 and the space available on the backboard 20 are limited and hence it has been difficult to increase the number of disks 130 on a backboard. Additionally, it has been difficult to meet the demand for disk apparatus of the RAID-0 category, those of the RAID-1 category and those of the RAID-0+1 category that operate at a higher speed.

### SUMMARY OF THE INVENTION

In view of the above-identified circumstances, it is therefore the object of the present invention to provide a disk connection unit, a disk package, a disk apparatus and a disk connection method that can improve the speed of operation and the reliability of the RAID categories.

In an aspect of the present invention, the above object is achieved by providing a disk connection unit to be used to utilize a plurality of disks by means of a single disk interface, the unit comprising: disk connectors dedicated to the respective disks in order to connect the respective disks; a RAID control section that performs RAID control operations on the plurality of disks by way of the disk connectors; and a disk I/F connector that connects the RAID control section to the disk interface.

Preferably, in a disk connection unit according to the invention, the RAID control section performs RAID control operations either for the RAID-0 category or for the RAID-1 category that is selected in advance.

Preferably, in a disk connection unit according to the invention, the plurality of disks are two SFF disks.

In another aspect of the present invention, there is provided a disk package to be connected to a disk interface, the package comprising: a plurality of disks; a RAID control section that performs RAID control operations on the plurality of disks; and at least a disk interface connector that is a connector to be used to connect the RAID control section to the disk interface.

Preferably, in a disk package according to the invention, the RAID control section performs RAID control operations either for the RAID-0 category or for the RAID-1 category that is selected in advance.

Preferably, in a disk package according to the invention, the plurality of disks are two SFF disks.

Preferably, in a disk package according to the invention, the size of the disk package matches the intervals of arrangement of the disk interfaces.

In still another aspect of the present invention, there is provided a disk apparatus having a feature of RAID, comprising: at least a disk package; at least a disk interface to be used to connect the disk package; and a first RAID control section that performs RAID control operations on the at least one disk package; the disk package including: a plurality of disks; a second RAID control section that performs RAID control operations on the plurality of disks; and at least a disk interface connector that is a connector to be used to connect the second RAID control section to the disk interface.

Preferably, in a disk apparatus according to the invention, the second RAID control section performs RAID control operations either for the RAID-0 category or for the RAID-1 category that is selected in advance.

Preferably, in a disk apparatus according to the invention, the first RAID control section indicates either the RAID-0 category or the RAID-1 category and the second RAID control section performs RAID control operations according to the indication by the first RAID control section.

Preferably, in a disk apparatus according to the invention, the plurality of disks are two SFF disks.

Preferably, in a disk apparatus according to the invention, the size of the disk package matches the intervals of arrangement of the disk interfaces.

In a further aspect of the present invention, there is provided a disk connection method to be used to utilize a plurality of disks by means of a single disk interface, the method comprising: connecting the plurality of disks; performing RAID control operations on the plurality of disks; and connecting the plurality of disks, on which RAID control operations are performed, to the disk interface as a disk package.

Thus, according to the invention, it is possible to connect two disks to a single disk interface as a result of using a disk connection unit and set up a RAID arrangement by using two disks. Additionally, it is no longer necessary to select either the RAID-0 category or the RAID-1 category by means of a host RAID control section and it is possible to realize a high speed data transfer rate by means of hardware RAID. Furthermore, it is possible to replace the disks of an existing disk apparatus by a disk package to realize high speed data transfer operations with a raised level of reliability when a disk package of a disk of the standard size and a disk of a size equal to or smaller than the standard size is used.

### BRIEF DESCRIPTION OF THE DRAWINGS

FIG. 1 is a schematic block diagram of an embodiment of disk apparatus according to the invention, showing the configuration thereof;

FIG. 2 is a schematic block diagram of an embodiment of disk connection unit according to the invention, showing the configuration thereof;

FIG. 3 is a schematic block diagram of another embodiment of disk apparatus according to the invention, showing the configuration thereof; and

FIG. 4 is a schematic block diagram of a known disk apparatus, showing the configuration thereof.

### DETAILED DESCRIPTION OF THE PREFERRED EMBODIMENTS

Now, the present invention will be described in greater detail by referring to the accompanying drawings that illustrate preferred embodiments of the invention.

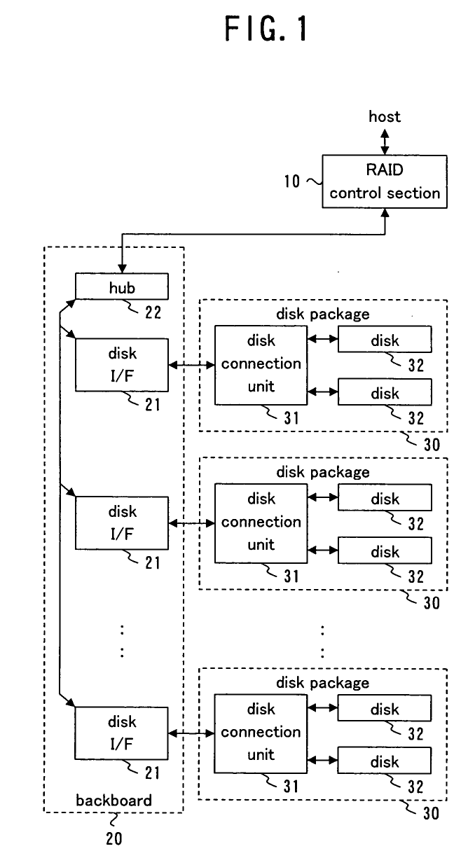

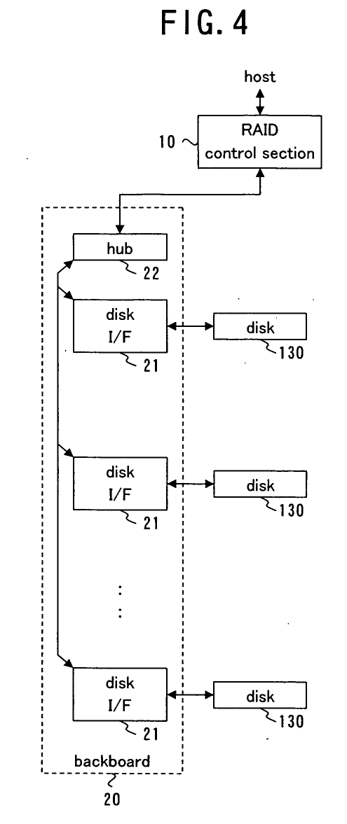

Firstly, a disk apparatus according to the invention will be described. FIG. 1 is a schematic block diagram of an embodiment of disk apparatus according to the invention, showing the configuration thereof. In FIG. 1, the components same as or similar to those of the disk apparatus of FIG. 4 are denoted respectively by the same reference symbols and will not be described any further. By comparing FIG. 1 and FIG. 4, it will be seen that the disk apparatus of FIG. 1 comprises a disk package 30 in place of the disks 130 of the disk apparatus of FIG. 4. The disk package 30 includes a disk connection unit 31 and two disks 32.

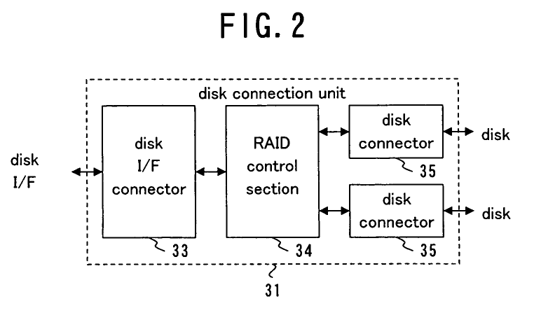

FIG. 2 is a schematic block diagram of an embodiment of disk connection unit according to the invention, showing the configuration thereof. The disk connection unit 31 comprises a disk interface (I/F) connector 33, a RAID control section 34 and two disk connectors 35. The RAID control section 34 performs RAID control operations on the two disks 32 by means of hardware. The RAID control section 34 can perform RAID control operations either for the RAID-0 category or for the RAID-1 category that is selected in advance. Thus, it is possible to connect two disks 32 to a single disk interface 21 by using the disk connection unit 31 and realize a RAID arrangement by using two disks 32. Additionally, as a result of using the RAID control section 34, it is no longer necessary to select either the RAID-0 category or the RAID-1 category by means of a host RAID control section and it is possible to realize a high speed data transfer rate by means of hardware RAID.

Normally, the intervals of the disk interfaces 21 on the backboard 20 conform to the standards of the disks of the standard size. In this embodiment, disks such as SFF (small form factor) disks having a thickness not greater than ½ of the thickness of disks of the standard size are used for the disks 32. As a result, the size of the disk package 30 can be made equal to or smaller than a disk of the standard size. Then, as a result of using such a disk package 30, it is possible to replace the disks of an existing disk apparatus by a disk package 30 to realize high speed data transfer operations with a raised level of reliability.

Now, some of the advantages of using the RAID control section 34 for the RAID-0 category will be discussed below. Since the data transfer rate of an FC is sufficiently higher than the data transfer rate of a disk 32, the disk package 30 can write and read data at a data transfer rate approximately twice as high as the data transfer rate of conventional disks when the RAID control section 34 is used for the RAID-0 category. If the RAID control section 10 is adapted to the RAID-1 category, it is also possible to raise the data transfer rate of the disk apparatus. Additionally, if the RAID control section 34 is adapted to the RAID-0 category while the RAID control section 10 is also adapted to the RAID-0 category and the use of two disk packages, the embodiment of disk apparatus according to the invention can write and read data at a data transfer rate about four times as fast as the data transfer rate of conventional disk apparatus that are not adapted to the RAID-0 category. In this way, it is possible to realize a high speed data transfer operation simply by replacing the disks of a conventional disk apparatus by a disk package 30 according to the invention and adapted to the RAID-0 category.

Some of the advantages of using the RAID control section 34 for the RAID-1 category will be discussed below. It is easy to replace the disks 32 at the time of failure or for the purpose of prevention of failure when the RAID control section 34 is used for the RAID-1 category. Therefore, if the RAID control section 10 is adapted to the RAID-0 category, it is possible to raise the reliability of the disk apparatus by using the RAID control section 34 for the RAID-1 category. In this way, the reliability of an existing disk apparatus is easily improved simply by replacing the disk of the apparatus by a disk package 30 adapted to the RAID-1 category according to the invention.

While the disks of the embodiment of FIG. 1 are adapted to be readable and writable from a single disk interface, they may alternatively be so adapted as to be readable and writable from two disk interfaces.

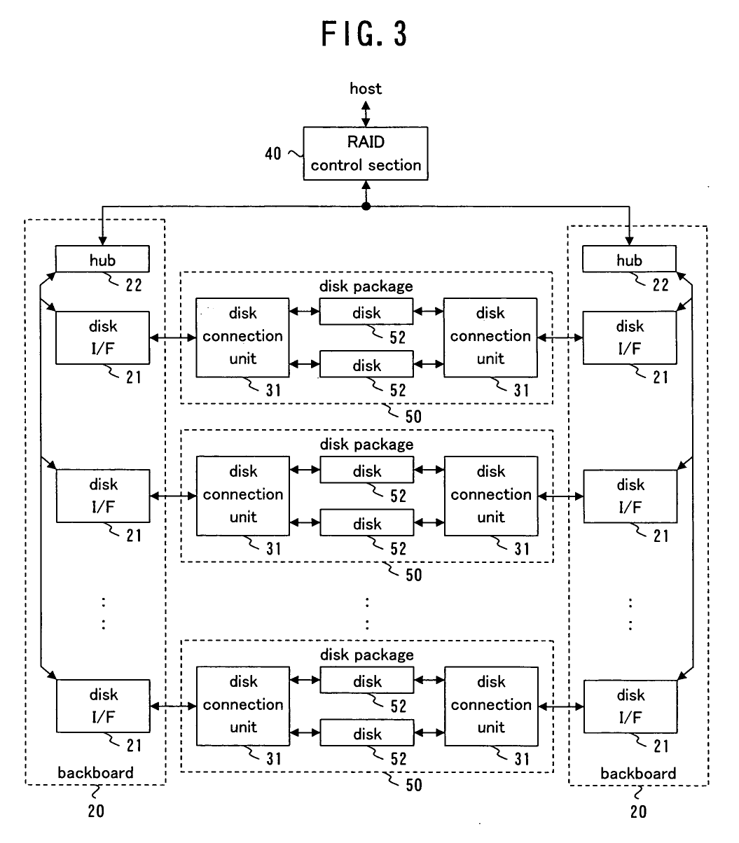

FIG. 3 is a schematic block diagram of another embodiment of disk apparatus according to the invention. In FIG. 3, the components same as or similar to those of FIG. 1 are denoted respectively by the same reference symbols and will not be described any further. By comparing the disk apparatus of FIG. 3 with that of FIG. 1, it will be seen that the disk apparatus of FIG. 3 comprises an additional backboard 20 and the RAID control section 10 and the disk package 30 of FIG. 1 are replaced respectively by a RAID control section 40 and a disk package 50. The disk package 50 by turn includes two disk connection units 31 and two disks 52. The two disks 52 are readable and writable from two disk interfaces and connected to two disk connection units 31.

While the RAID control sections 34 of the above described embodiments are adapted to select the RAID-0 category or the RAID-1 category in advance, it may alternatively be so arranged that the RAID control section 10 selects either the RAID-0 category or the RAID-1 category for each and every RAID control section 34. Additionally, while each and every RAID control section 34 is adapted to either the RAID-0 category or the RAID-1 category in the above described embodiments, it may alternatively be adapted to some other RAID category.

Furthermore, while the number of disks 32 of a disk package 30 is two in the above described embodiments, the number of disks 32 of a disk package 30 and hence the number of disk connectors 35 of a disk connection unit 31 may be made to be three or more than three by expanding the intervals of the disk interfaces 21 or by reducing the size of the disks 32.

For the purpose of the present invention, the first RAID control section refers to the RAID control sections 10, 40 of the above-described embodiments and the second control section refers to the RAID control section 34 of the above described embodiments.

What is claimed is:

1. A disk connection unit to be used to utilize a plurality of disks by means of a single disk interface, the unit comprising:
disk connectors dedicated to the respective disks in order to connect the respective disks;
a RAID control section that performs RAID control operations on the plurality of disks by way of the disk connectors; and
a disk I/F connector that connects the RAID control section to the disk interface.

2. The disk connection unit according to claim 1, wherein the RAID control section performs RAID control operations either for the RAID-0 category or for the RAID-1 category that is selected in advance.

3. The disk connection unit according to claim 1, wherein the plurality of disks are two SFF disks.

4. A disk package to be connected to a disk interface, the package comprising:
a plurality of disks;
a RAID control section that performs RAID control operations on the plurality of disks; and
at least a disk interface connector that is a connector to be used to connect the RAID control section to the disk interface.

5. The disk package according to claim 4, wherein the RAID control section performs RAID control operations either for the RAID-0 category or for the RAID-1 category that is selected in advance.

6. The disk package according to claim 4, wherein the plurality of disks are two SFF disks.

7. The disk package according to claim 4, wherein the size of the disk package matches the intervals of arrangement of the disk interfaces.

8. A disk apparatus comprising:
at least a disk package;
at least a disk interface to be used to connect the disk package; and
a first RAID control section that performs RAID control operations on the at least one disk package;
the disk package including:
a plurality of disks;
a second RAID control section that performs RAID control operations on the plurality of disks; and
at least a disk interface connector that is a connector to be used to connect the 11 second RAID control section to the disk interface.

9. The disk apparatus according to claim 8, wherein the second RAID control section performs RAID control operations either for the RAID-0 category or for the RAID-1 category that is selected in advance.

10. The disk apparatus according to claim 8, wherein the first RAID control section indicates either the RAID-0 category or the RAID-1 category and the second RAID control section performs RAID control operations according to the indication by the first RAID control section.

11. The disk apparatus according to claim 8, wherein the plurality of disks are two SFF disks.

12. The disk apparatus according to claim 8, wherein the size of the disk package matches the intervals of arrangement of the disk interfaces.

13. A disk connection method to be used to utilize a plurality of disks by means of a single disk interface, the method comprising:
connecting the plurality of disks;
performing RAID control operations on the plurality of disks; and
connecting the plurality of disks, on which RAID control operations are performed, to the disk interface as a disk package.
